(19) United States
(12) Patent Application Publication
(10) Pub. No.: US 2026/0065523 A1
(43) Pub. Date: Mar. 5, 2026

(54) SAMPLER FOR A MASKED DIFFUSION MODEL

(71) Applicant: NVIDIA Corporation, Santa Clara, CA (US)

(72) Inventors: Qinsheng Zhang, Atlanta, GA (US); Kaiwen Zheng, Santa Clara, CA (US); Ming-Yu Liu, Redwood City, CA (US); Yongxin Chen, Suwanee, GA (US); Hanzi Mao, Sunnyvale, CA (US)

(21) Appl. No.: 19/294,119

(22) Filed: Aug. 7, 2025

Related U.S. Application Data
(60) Provisional application No. 63/687,712, filed on Aug. 27, 2024.

(51) Int. Cl. G06T 11/00; G06F 40/284; G06F 40/40

(52) U.S. Cl. CPC G06T 11/00; G06F 40/284; G06F 40/40; G06T 2210/52

(57) ABSTRACT

Masked diffusion models (MDMs), a variant of discrete diffusion formulations, generally use a gradual unmasking process that can generate tokens in any order. These MDMs are useful to generate discrete data, such as text, images, and other sequential data. However, the sampling of MDMs, which is performed in continuous time, traditionally requires that each sampling step make a forward pass through the network even though a single sampling step may result in no changes to any token in the sequence. The present disclosure provides a first hitting sampler for an MDM which, for at least one or more sampling steps, can more efficiently make predictions for unmasking tokens in an input sequence.

### CLAIM OF PRIORITY

This application claims the benefit of U.S. Provisional Application No. 63/687,712 (Attorney Docket No. NVIDP1411+/24-SC-1068US01) titled “EFFICIENT ALGORITHM TO DRAW SAMPLES FROM MASKED DIFFUSION MODELS,” filed Aug. 27, 2024, the entire contents of which is incorporated herein by reference.

### TECHNICAL FIELD

The present disclosure relates to the sampling process of masked diffusion models.

### BACKGROUND

There are three primary paradigms of generative models. Diffusion models have been the prevalent way for generative modeling of continuous data with both theoretical and empirical success. They are state-of-the-art in image, speech, and video synthesis and serve as the cornerstone of large-scale text-to-image and text-to-video generation systems. Auto-regressive models (ARMs) have dominated the generation of discrete data, especially including languages, due to the scalability and generalizability of the straightforward next-token-prediction mechanism based on transformer architectures. Masked models, configured for both masked language modeling and masked image generation, are trained to reconstruct randomly masked tokens sampled by order-agnostic decoding. They are an alternative approach to model discrete data while suffering from insufficient theoretical foundations.

Diffusion models have been extended to discrete data spaces with principled training and sampling. Compared to ARMs, they predict all tokens simultaneously and offer a favorable trade-off between generation quality and sampling efficiency. Recently, masked diffusion models (MDMs), the leading variant of discrete diffusion formulations, are emerging as a promising contender of ARMs. Recent works have simplified MDMs to align with the design space of diffusion models via continuous-time forward processes, training objectives, and sampling procedures, resulting in a unified view and empirical improvements. Positioned at the intersection of diffusion models and masked models, MDMs are considered promising as they inherit both the theoretical principles from diffusion models and the simple mechanism from masked models. Moreover, it is believed that MDMs can outperform ARMs in text generation when measured by the common generative perplexity metric.

However, the sampling of MDMs, which is performed in continuous time, traditionally requires that each sampling step make a forward pass through the network even though a single sampling step may result in no changes to any token in the sequence. There is a need for addressing these issues and/or other issues associated with the prior art. For example, there is a need to employ a sampler for an MDM which, for at least one or more sampling steps, can more efficiently make predictions for unmasking tokens in an input sequence.

### SUMMARY

A method, computer readable medium, and system are disclosed for using a masked diffusion model to unmask one or more mask tokens in an input sequence. One or more mask tokens included in an input sequence are unmasked over a plurality of sampling steps, by a masked diffusion model, to generate an unmasked sequence, where a prediction made during at least one sampling step of the plurality of sampling steps is one of: estimated using linear extrapolation from two or more prior predictions made during respective prior sampling steps of the plurality of sampling steps, or computed from a current decoding result refined from a prior prediction made during a prior sampling step of the plurality of sampling steps. The unmasked sequence is output.

### BRIEF DESCRIPTION OF THE DRAWINGS

FIG. 1 illustrates a method to unmask one or more mask tokens in an input sequence, in accordance with an embodiment.

FIG. 2 illustrates a method of a token-by-token sampler, in accordance with an embodiment.

FIG. 3 illustrates exemplary outputs of different samplers of a masked diffusion model, in accordance with an embodiment.

FIG. 4 illustrates a method for using linear interpolation on prior predictions during a sampling step of a masked diffusion model, in accordance with an embodiment.

FIG. 5 illustrates a method for using a refined prior prediction during a sampling step of a masked diffusion model, in accordance with an embodiment.

FIG. 6 illustrates a text generation method, in accordance with an embodiment.

FIG. 6 illustrates an exemplary input and output of the inpainting method of FIG. 5, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

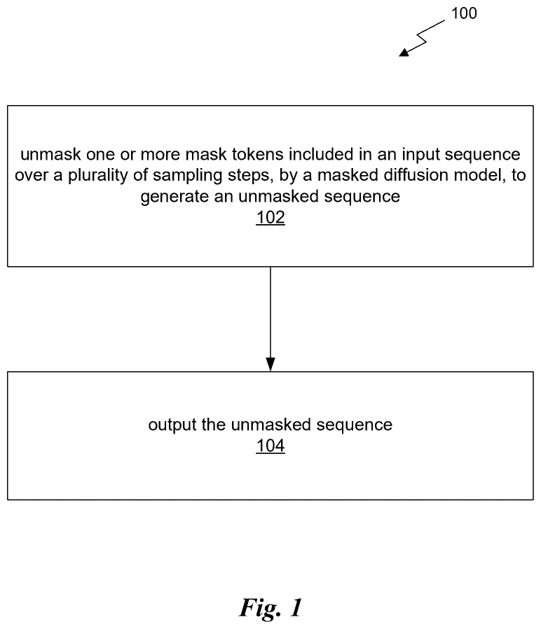

FIG. 1 illustrates a method 100 to unmask one or more mask tokens in an input sequence, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, one or more mask tokens included in an input sequence are unmasked over a plurality of sampling steps, by a masked diffusion model, to generate an unmasked sequence. The input sequence refers to any sequence of data elements that includes a single mask token or a plurality of mask tokens. A mask token refers to a data element in the sequence for which content (e.g. a text element, an image element, etc.) is to be generated by the masked diffusion model. In an embodiment, the mask tokens may be noisy tokens in the input sequence.

In an embodiment, the input sequence is an encoding of an image having one or more masked regions. In this embodiment, the one or more mask tokens may be representations of the one or more masked regions, for example. In an embodiment, the unmasked sequence generated from the encoding of the image may be a complete image (e.g. without the one or more masked regions).

In another embodiment, the input sequence is an encoding of a text having one or more masked portions. In this embodiment, the one or more mask tokens may be representations of the one or more masked portions, for example. In an embodiment, the unmasked sequence generated from the encoding of the text may be a complete text (e.g. without the one or more masked portions).

As mentioned, the one or more mask tokens included in the input sequence are unmasked over a plurality of sampling steps, by a masked diffusion model, to generate an unmasked sequence. The masked diffusion model refers to a generative neural network trained to unmask each mask token included in a given input sequence by generating data for the mask token. The masked diffusion model employs a sampling process comprised of a plurality of sampling steps over which the one or more mask tokens included in the input sequence are unmasked.

In an embodiment, the masked diffusion model is configured to unmask a plurality of mask token in the input sequence in any order (i.e. the masked diffusion model is not constrained to unmasking the mask tokens in sequence). In an embodiment, the masked diffusion model is configured to unmask a plurality of mask tokens in parallel. For example, in the present operation 102, the unmasking of at least two mask tokens in the plurality of mask tokens of the input sequence may be performed in parallel. In an embodiment, the masked diffusion model is configured to employ a token-by-token sampling process. Thus, the unmasking by the masked diffusion model may include the token-by-token sampling process, where for example at least one mask token is unmasked during each sampling step of the plurality of sampling steps.

While one or more of the sampling steps include processing through the masked diffusion model neural network, with respect to the unmasking of the present operation 102, a prediction made during at least one sampling step of the plurality of sampling steps is made without processing through the masked diffusion model neural network. In particular, with respect to the unmasking of the present operation 102, a prediction made during at least one sampling step of the plurality of sampling steps is one of: estimated using linear extrapolation from two or more prior predictions made during respective prior sampling steps of the plurality of sampling steps, or computed from a current decoding result refined from a prior prediction made during a prior sampling step of the plurality of sampling steps.

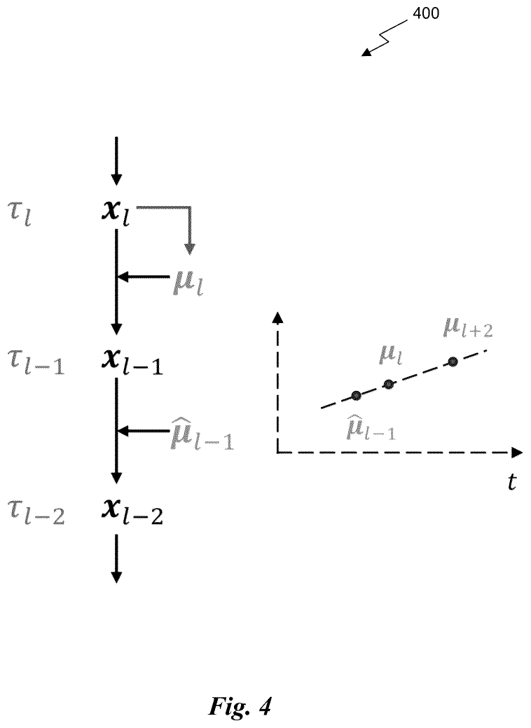

A prediction may refer to the unmasking of a mask token, or in other words the generation of content for the input sequence. In one embodiment of the present method 100, the prediction made during the at least one sampling step of the plurality of sampling steps is estimated using the linear extrapolation from the two or more prior predictions made during the respective prior sampling steps of the plurality of sampling steps. In an embodiment, Lagrange polynomials may be used to interpolate the two or more prior predictions along a time axis to estimate the prediction at a current sampling step. In an embodiment, the two or more prior predictions may include two of the most recent predictions made by the masked diffusion model (e.g. at the prior to sampling steps). More details of using linear extrapolation will be described below with reference to FIG. 4.

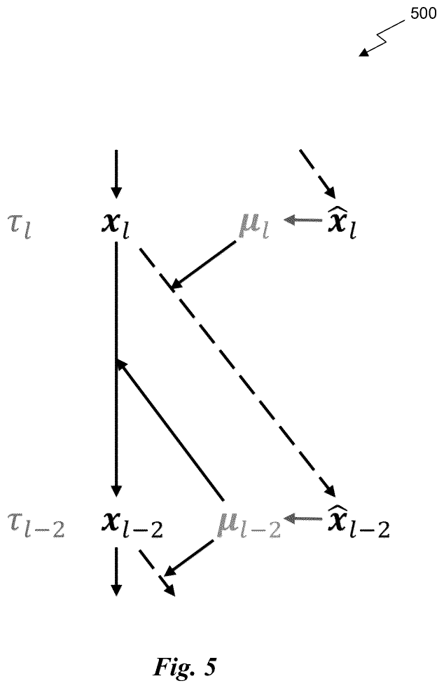

In another embodiment of the method 100, the prediction made during the at least one sampling step of the plurality of sampling steps is computed from the current decoding result that has been refined from the prior prediction made during the prior sampling step of the plurality of sampling steps. In an embodiment, the current decoding result that has been refined may be prevented from being fed back into the masked diffusion model for prediction updates. More details of using a refined decoding result will be described below with reference to FIG. 5.

In an embodiment, when a number of sampling steps in the plurality of sampling steps is less than or equal to a first threshold (e.g. 128), then the prediction made during the at least one sampling step of the plurality of sampling steps is estimated using the linear extrapolation. In an embodiment, when a number of sampling steps in the plurality of sampling steps is greater than or equal to a second threshold (e.g. 256), then the prediction made during the at least one sampling step of the plurality of sampling steps is computed from the current decoding result.

In operation 104, the unmasked sequence is output. In an embodiment, the unmasked sequence may be output to a display device for viewing by a user. In an embodiment, the unmasked sequence may be output to a memory. In an embodiment, the unmasked sequence may be output to a downstream task that is configured to process the unmasked sequence. Just by way of example, where the input sequence is a representation of an image having one or more masked regions that has been captured by an autonomous driving vehicle system, then the unmasked sequence (e.g. the complete image) may be output to the autonomous driving vehicle system for use in making one or more autonomous driving decisions.

To this end, the method 100 unmasks one or more mask tokens in an input sequence by computationally deriving one or more predictions from historical predictions (i.e. via linear extrapolation or prediction refinement, as described above). Computationally making a prediction is less resource intensive than making the prediction directly by the masked diffusion model, and thus the method 100 may save compute resources during the unmasking process.

Further embodiments will now be provided in the description of the subsequent figures. It should be noted that the embodiments disclosed herein with reference to the method 100 of FIG. 1 may apply to and/or be used in combination with any of the embodiments of the remaining figures below.

Nomenclature for the embodiments described below are listed in Table 1.

TABLE 1
Numbers and Arrays

| | |
|---|---|
| X | A scalar representing a discrete token |
| X | A vector representing a sequence of discrete tokens |
| X^{(l)} | The l-th element of x |
| Xₜ, Xₜ | The state(s) at time t |
| Xₙ | The sequence with n masked tokens |
| t | The continuous time |
| m | The mask token |
| n | The number of masked tokens in a sequence |
| μ | A matrix, where the l-th column represents the predicted transition probabilities at the l-th |
| | position in a sequence |
| μ₍ₗ₎ | The l-th column of μ |
| π | The class probabilities |
| πᵢ | The i-th element of π |
| L | The sequence length |
| N | The number of sampling steps |
| B | The batch size |
| θ | The neural network parameters |
| τ | The first-hitting time |
| L_{∞} | The continuous-time NELBO loss for a single token |
| L_{∞}^{(L)} | The continuous-time NELBO loss for a sequence of length L |

Sets

| | |
|---|---|
| R | The set of real numbers |
| X | The discrete data space (vocabulary) {0, 1, . . . , m} where m is the added mask token |
| Δ^{m} | $The standard m - simplex \{ π ∈ {ℝ}^{m + 1} \vert {\sum }_{i = 0}^{m} {π}_{i} = 1 , π \geq 0 \}$ |

Functions

| | |
|---|---|
| αₜ | The pre-defined noise schedule, which is a decreasing function of time t |
| ${α}_{t}^{′}$ | The derivative of the noise schedule w.r.t. the time |
| α⁻¹(a) | The inverse function of the noise schedule satisfying α_{α}_{^{−1}}₍ₐ₎ = a |
| δ_{x,y} | The indicator function (1 when x = y and 0 when x ≠ y) |
| eₓ | The one-hot vector of the token x |
| μ_{θ}(x, t) | The network prediction given the sequence x and the time t as input |
| softmax(z) | The Softmax operation to transform logits into class probabilities |
| log μ | The element-wise natural logarithm |
| N(x) | The function counting the number of masked tokens in the sequence x |
| \|X\| | The size of the vocabulary X |

Distributions

| | |
|---|---|
| q | The continuous-time forward process |
| \tilde{q} | The discrete forward process |
| p_{θ} | The parameterized reverse process |
| U(a, b) | The uniform distribution on the interval [a, b] |
| B(a, b) | The Beta distribution with parameters a, b > 0 |
| G(0, 1) | The standard Gumbel distribution |
| T G(0, 1, M) | The right-truncated standard Gumbel distribution with threshold M |
| Cat(π) | The categorical distribution over the class probabilities π |

### Masked Diffusion Models (MDMs)

Let X={0, 1, . . . , m−1} be the discrete data space, with an extra mask token m added to X. Denote

$${Δ}^{m} = \{ π ∈ {ℝ}^{m + 1} \vert {\sum }_{i = 0}^{m} 1 , π \geq 0 \}$$

as the standard m-simplex. For any data token or mask token x∈X, denote eₓ∈ [symbol] ^{m+1} as the corresponding one-hot vector. Continuous-time discrete-space masked diffusion models (MDMs) can be defined akin to diffusion models, with a continuous-time forward noising process, per Equation 1.

$${q}_{t \vert 0} ( {x}_{t} \vert {x}_{0} ) = Cat ( {α}_{t} {e}_{{x}_{0}} + ( ( 1 - {α}_{t} ) {e}_{m} \qquad Equation 1$$

where αₜ is the predefined noise schedule function satisfying α₀≈1, α₁=0, and Cat(π) denotes the categorical distribution over the class probabilities π∈Δ^{m}. The forward process has a time reversal for s<t given x₀, per Equation 2.

$${q}_{s \vert t , 0} ( {x}_{s} \vert {x}_{t} , {x}_{0} ) = \{ \begin{matrix}Cat ( {e}_{{x}_{t}} ) \\ Cat ( \frac{( 1 − {α}_{s} ) {e}_{m} + ( {α}_{s} − {α}_{t} ) {e}_{{x}_{0}}}{1 − {α}_{t}} ) , \begin{matrix}{x}_{t} \neq m \\ {x}_{t} = m\end{matrix}\end{matrix} \qquad Equation 2$$

Following denoising diffusion probabilistic models (DDPM), the parameterized model is defined by replacing eₓ_{₀} in the reversal with a data prediction model μ_{θ}: X× [symbol] ^{m}, per Equation 3.

$${p}_{θ} ( {x}_{s} \vert {x}_{t} ) : = q ( {x}_{s} \vert {x}_{t} , {e}_{{x}_{0}} ← {μ}_{θ} ( {x}_{t} , t ) ) \qquad Equation 3$$

and μ_{θ} is further parameterized by f_{θ}: X× [symbol] → [symbol] ^{m} as per Equation 4.

$${μ}_{θ} ( {x}_{t} , t ) = \{ \begin{matrix}[ softmax ( {f}_{θ} ( {x}_{t} , t ) ) , 0 ] , & {x}_{t} = m \\ {e}_{{x}_{t}} , & {x}_{t} \neq m\end{matrix} \qquad Equation 4$$

so that it satisfies (1) the predicted vector contains valid class probabilities sum to 1; (2) the predicted x₀ has zero probability of being the mask token; (3) if a token is already unmasked, it no longer changes. When α₀→1, α₁→0 and the number of timesteps tends to infinity, it is proven that the parameterized model p_{θ} has an evidence lower bound (ELBO) log p_{θ}(x₀)≥− [symbol] _{∞}, per Equation 5.

$${ℒ}_{∞} = {\int }_{0}^{1} \frac{{α}_{t}^{′}}{1 - {α}_{t}} {𝔼}_{{q}_{t \vert 0} ( {x}_{t} \vert {x}_{0} )} [ {δ}_{{x}_{t} , m} {e}_{{x}_{0}}^{T} log {μ}_{θ} ( {x}_{t} , t ) ] dt \qquad Equation 5$$

is a time-weighted cross-entropy loss,

$${α}_{t}^{′} = \frac{d {α}_{t}}{d t} ,$$

and δₓ_{ₜ}_{,m} is an indicator function. L_{∞}, the training objective, is referred to as the negative ELBO (NELBO).

Multi-Dimensional Case For a token sequence x∈X^{L}=(0, 1, . . . , m−1, m)^{L} of length L, MDMs choose a factorized forward process

$${q}_{q \vert 0} ( {x}_{t} \vert {x}_{0} ) = {\prod }_{l = 0}^{L} {q}_{t \vert 0} ( {x}_{t}^{( l )} \vert {x}_{0}^{( l )} )$$

over different dimensions, where x(l) denotes the l-th token of x. As a result, the reversal

$${q}_{s \vert t , 0} ( {x}_{s} \vert {x}_{t} , {x}_{0} ) = {\prod }_{l = 1}^{L} {q}_{s \vert t , 0} ( {x}_{s}^{( l )} \vert {x}_{t}^{( l )} , {x}_{0}^{( l )} )$$

and the parameterized model

$${p}_{θ} ( {x}_{s} \vert {x}_{t} ) = {\prod }_{l = 1}^{L} q ( {x}_{s}^{( l )} \vert {x}_{t}^{( l )} , {e}_{{x}_{0}^{( l )}} ← {μ}_{θ}^{( l )} ( {x}_{t} , t ) )$$

also factorize. Here the network μ_{θ}: X× [symbol] →(Δ^{m})^{L} predicts the probabilities at all positions at a time, and

$${μ}_{θ}^{( l )}$$

is used to denote the l-th column of μ_{θ}. The ELBO loss in Equation 5 under multi-dimension can be written per Equation 6.

$${ℒ}_{∞}^{( L )} = {\int }_{0}^{1} \frac{{α}_{t}^{′}}{1 - {α}_{t}} {E}_{{q}_{t \vert 0} ( {x}_{t} \vert {x}_{0} )} [ {\sum }_{l : {x}_{t}^{( l )} = m} {e}_{{x}_{0}^{( l )}}^{T} log {μ}_{θ}^{( l )} ( {x}_{t} , t ) ] dt \qquad Equation 6$$

Context of Discrete Diffusion Models MDMs described above are a simplified version of the best-performing masked (or absorbing) case in discrete-space diffusion models. Discrete diffusion models rely on discrete-time or continuous-time Markov chains to model transitions in discrete space. Notably, concrete score in discrete diffusion acts as an analog of the score function in continuous diffusion, and score entropy may be used for robust and scalable learning of the concrete score. The model definition (Markov chain, score parameterization), training objective (diffusion-weighted denoising score entropy) and sampling procedure (Tweedie τ-leaping) can be proven equivalent to the simplified expressions (Equations 1, 3, 4 and 5) in MDMs.

### Training of MDMs

MDMs are defined and trained by the continuous-time forward process (Equation 1) time-dependent network parameterization (Equation 4) and continuous-time ELBO (Equation 5). However, different from continuous-time diffusion models, the evolution of xₜ is discrete. The evolution trajectories of (xₜ, t) are like pairs of “phenotype” and “genotype”, where the continuous changes in time t may not be reflected on the observable traits of xₜ. In the following description, we aim to disentangle the internal time variable t and the external traits of the masked sequence xₜ in the training of MDMs.

Reformulating the ELBO with the Number of Masked Tokens

Previous works show the invariance of the ELBO to the noise schedule αₜ by performing the time change-of-variable γ=log(1−αₜ) or

$$λ = log \frac{{α}_{t}}{1 - {α}_{t}} .$$

However, this does not get to the essence as they still rely on an internal continuous time. In the following embodiment, it is shown that the sequence NELBO of MDMs can be expressed as a partition by the number of masked tokens instead of the continuous time.

Proposition 1 (ELBO by the Number of Masked Tokens). For x₀ with sequence length L, denote xₙ as a sequence with n masked tokens, and q′(xₙ|x₀) as the discrete forward process which randomly and uniformly masks n tokens of x₀. Suppose the noise schedule αₜ satisfies α₀=1, α₁=0. The sequence NELBO in Equation 6 can be reformulated as Equation 7.

$${ℒ}_{∞}^{( L )} = - {\sum }_{n = 1}^{L} {𝔼}_{{q}_{n \vert 0}^{′} ( {x}_{n} \vert {x}_{0} )} [ \frac{1}{n} {\sum }_{l : {x}_{n}^{( l )} = m} {e}_{{x}_{0}^{( l )}}^{T} log {\overline{μ}}_{θ}^{( l )} ( {x}_{n} ) ] \qquad Equation 7$$

where log μ̅_{θ}(xₙ) is defined per Equation 8.

$$log {\overline{μ}}_{θ} ( {x}_{n} ) = {𝔼}_{{α}_{n} ∼ B ( L - n + 1 , n )} [ log {μ}_{θ} ( {x}_{n} , {α}^{- 1} ( {α}_{n} ) ) ] \qquad Equation 8$$

where α−1 is the inverse function of αₜ satisfying α−1(αₜ)=t, and B(a, b) denotes the Beta distribution with shape parameters a, b>0.

This expression offers two aspects of theoretical insights:
1. Mixture of Experts: From Equation 8, the time-dependent network μ_{θ}(x, t) implicitly parameterizes a time-independent network μ̅_{θ}(x) by aggregating the logarithm at the same x but different t, which can be seen as an ensemble. The time t is sampled unevenly so that αₜ follows a Beta distribution B(L−n+1, n). This distribution has the mode

$$( peak ) \frac{L - n}{L - 1} and variance \frac{n ( L - n + 1 )}{{( L + 1 )}^{2} ( L + 2 )} \leq \frac{1}{4 ( L + 2 )} .$$

With a large sequence length L, the variance is small and the distribution is concentrated around the mode. Moreover, under the best-performing linear schedule αₜ=1−t in MDMs, the mode of t is

$$\frac{n - 1}{L - 1} ,$$

close to the masked ratio n/L. Therefore, the time variable t can be seen as a continuous relaxation and smoothing of the masked ratio, and the network can be directly conditioned on the discretely distributed masked ratio instead of the continuous time while yielding similar performance.
2. Discrete ELBO: From Equation 7, the sequence NELBO can be expressed discretely with the time-agnostic network μ̅_{θ}(x). Therefore, Equation 7 can serve as a NELBO of masked models in a straightforward way: uniformly choose the number of masked tokens n from {1, . . . , L}, uniformly mask n random tokens in x₀ to obtain xₙ, and compute the average cross-entropy loss of μ̅_{θ}(x) on these n positions. The weighting 1/n in this NELBO resembles the likelihood weighting in diffusion models, facilitating maximum likelihood training of masked models.

### Time-Independent Network Parameterization

When the original network pe is parameterized without the time input, we have μ̅_{θ}=μ_{θ} in Equation 7. In this case, the training of MDMs is completely free from the time variable and behaves like masked models.

Proposition 2 (Optimal Masked Diffusion Model). Given unlimited model capacity, the optimal network θ* that minimizes the NELBO in Equation 6 satisfies Equation 9.

$${μ}_{{θ}^{*}}^{( l )} ( {x}_{t} , t ) = {𝔼}_{{q}_{0 \vert N ( x )}^{′} ( {x}_{0} \vert x )} [ {e}_{{x}_{0}^{( l )}} ] \qquad Equation 9$$

where N(x) is a deterministic function that counts the number of masked tokens in x, and

$${q}_{0 \vert n}^{′} ( {x}_{0} \vert {x}_{n} )$$

is the posterior distribution of the discrete forward process

$${q}_{n \vert 0}^{′} ( {x}_{n} \vert {x}_{0} ) .$$

From the above expression, the optimal MDM is irrelevant to the time variable, justifying the feasibility of removing the time input. Besides, it can be extended to a general weighted cross-entropy loss

$${ℒ}_{w}^{( L )} = - {\sum }_{n = 1}^{L} {w}_{n} {𝔼}_{{q}_{n \vert 0}^{′} ( {x}_{n} \vert {x}_{0} )} [ {\sum }_{l : {x}_{n}^{( l )} = m} {e}_{{x}_{0}^{( l )}}^{T} log {μ}_{θ}^{( l )} ( {x}_{n} ) ]$$

of masked models.

$${ℒ}_{w}^{( L )}$$

with arbitrary positive weights w>0 yields the same optimal solution as Equation 9, thus acting as a surrogate objective of the NELBO. This theoretically supports a wide range of objectives for training masked models.

### Sampling of MDMs

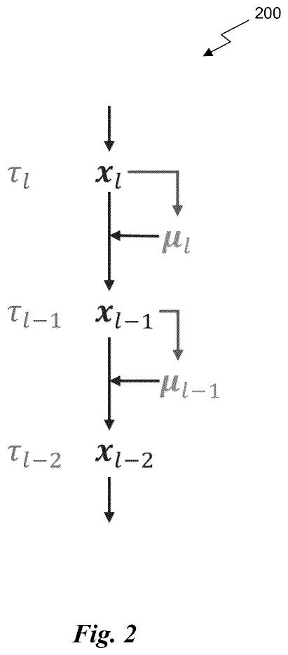

In the above disclosure, it is demonstrated how the training of MDMs, both theoretically and empirically, can be disentangled with the continuous time variable and behave like masked models. The following description focuses on the sampling of MDMs, which is also performed in continuous time and seems distinct from masked models. Embodiments of FIGS. 2-4 described below address the inefficiency problem of current sampling procedures used for MDMs.

### Inefficiency of Current Sampling

MDMs are sampled in an ancestral way following the parameterized reverse-time process in Equation 3. Specifically, the sampling step xₜ→xₛ from time t to s<t can be expressed per Equation 10.

$$Equation 10$$

$${x}_{s}^{( l )} \{ \begin{matrix}= {x}_{t}^{( l )} , & & \\ ∼ Cat ( \frac{1 - {α}_{s} ) {e}_{m} + ( {α}_{s} - {α}_{t} ) {μ}_{θ}^{( l )} ( {x}_{t} , t )}{1 - {α}_{t}} ) , & \begin{matrix}{x}_{t}^{( l )} \neq m \\ {x}_{t}^{( l )} = m\end{matrix} , & for every l\end{matrix}$$

Given the number of sampling steps N, the sampling process involves first discretizing the timesteps as 0=t₀<t₁< . . . <t_{N=1}, and then performing reverse steps t_{N}→t_{N-1}→ . . . →t₀ according to Equation 10. Notable characteristics of MDM's sampling include: (1) Any mask token can only be unmasked once with no further changes. (2) Each sampling step requires a forward pass through the network pe and conducting at most L times of JX|-dimensional categorical sampling, where L is the sequence length and |X| is the vocabulary size. (3) The number of sampling steps N can be significantly larger than L, and a single sampling step may result in no changes to any token in the sequence. (4) As MDMs are trained with the continuous-time ELBO which assumes an infinite number of reverse steps, it is theoretically rigorous to employ an equivalently large N.

Recent works propose a simple caching strategy to speed-up the sampling of MDMs: when the network μ_{θ} is parameterized without time input, and the sequence is not changed in a sampling step t→s (i.e., xs=xt), we can reuse the network output at the last step as μ_{θ}(xₛ)=μ_{θ}(xₜ). As the sequence changes at most L times during sampling, the number of function evaluations (NFE) can be reduced to no more than L. However, sampling with the caching strategy still suffers from two major inefficiency problems:
1. Categorical Sampling is Time-Consuming In diffusion models, NFE is an efficient indicator of the sampling speed, as the computation overhead beyond the network forward passes is negligible. However, in MDMs, the Gumbel-based5 categorical sampling, which requires sampling a total number of O(NL|X|) uniform variables and performing logarithmic operations on them, can be expensive compared to network evaluations. Categorical sampling steps that do not result in token changes are wasted, as they contribute no information gain.
2. Caching Strategy Degrades in Batched Sampling When using the caching strategy in batched sampling, the network output can only be reused directly when all the sequences in the batch remain unchanged after a sampling step. Suppose the batch size is B, and the default linear noise schedule αₜ=1−t as well as uniform timesteps

$${t}_{k} = \frac{k}{N}$$

is used. The expected NFE under the caching strategy can be derived as

$$N ( 1 - {( 1 - \frac{1}{N} )}^{BL} ) .$$

### As

$${lim}_{N \to ∞} N ( 1 - {( 1 - \frac{1}{N} )}^{BL} ) = BL ,$$

the NFE is no longer upper bounded by the sequence length but scales with the batch size.

The current sampling methods of MDMs, including the caching strategy, are neither efficient nor insightful into the essence of MDMs. FIGS. 2-5 below describe embodiments of more efficient sampling methods for MDMs, when compared with the current sampling methods described above.

When the number of sampling steps N→∞ and the maximum step size max_{1≤i≤N}|tᵢ−tᵢ−1|→0, Equation 10 tends to an infinitesimal jump. In this case, the reverse sampling process becomes a continuous-time Markov chain (or Markov process), where each mask token is unmasked at some moment according to the network prediction. Embodiments herein involve three folds: (1) Whether a mask token will transit or not during a time interval [s, t] is independent of the network. The network output only determines which token is the transition target given the condition that the transition happens. (2) The transition probability

$$\frac{{α}_{s} - {α}_{t}}{1 - {α}_{t}}$$

is equal for masked tokens at different positions. Therefore, each mask token has the same probability of being first unmasked. (3) The first-hitting time, which denotes the first moment any of the remaining masked tokens is unmasked, can be analytically sampled per the following proposition.

Proposition 3 (Analytic Sampling of First-Hitting Time). Denote τ_{L}=1 as the initial time. Suppose there are n masked tokens, and the last time a token is unmasked happens at τₙ, then the next time a token is unmasked can be analytically sampled by Equation 11.

$${τ}_{n - 1} = {α}^{- 1} ( 1 - {u}_{n}^{\frac{1}{n}} ( 1 - {α}_{{τ}_{n}} ) ) , {u}_{n} ∼ ( U ( 0 , 1 ) \qquad Equation 11$$

where U(0, 1) is the uniform distribution on [0, 1].

Algorithm 1 provides an embodiment of first hitting sampling of MDMs.

Algorithm 1

Require: the sequence length L, the vocabulary X = {0, . . . , m − 1, m} where m is the mask
token, the noise schedule αₜ and its inverse function α⁻¹, the pretrained masked diffusion model
μ_{θ}

| | |
|---|---|
| 1: | x_{L} ← [mm ... m] |
| 2: | τ_{L} ← 1 |
| 3: | for n ← L to 1 do |
| 4: | Sample uₙ ~ U(0, 1) |
| 5: | ${τ}_{n - 1} ← {α}^{- 1} ( 1 - {u}_{n}^{\frac{1}{n}} ( 1 - {α}_{{τ}_{n}} ) )$ |
| 6: | μₙ ← μ_{θ}(xₙ, τₙ₋₁) |
| 7: | Randomly and uniformly select an index 1 from |
| | $\{ i : {x}_{n}^{( i )} = m \}$ |
| | (i.e., masked positions in xₙ) |
| 8: | ${x}_{n - 1} ← {x}_{n} , {x}_{n - 1}^{( l )} ← Cat ( {μ}_{n}^{( l )} )$ |
| 9: | end for |

Output: x₀

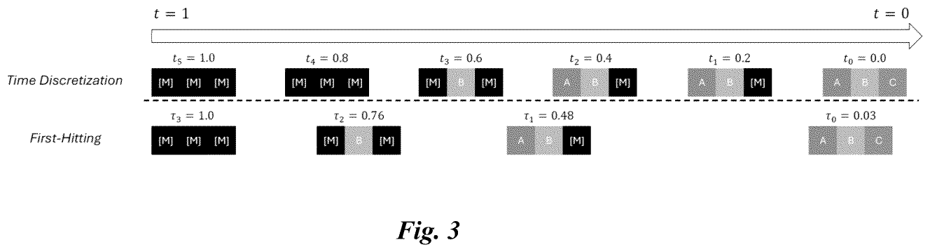

As outlined in Algorithm 1, by recursively sampling the next time when any of the remaining mask tokens is first unmasked, then uniformly choosing a mask token and unmasking it according to the network output, a token-by-token sampling procedure of MDMs is obtained. Denote xₙ as the sequence with n remaining mask tokens. Since the transition xₙ→xₙ₋₁ can be considered to happen in the infinitesimal step τₙ₋₁+dt→τₙ₋₁, using the network output μ_{θ}(xₙ, τₙ₋₁) at time τₙ₋₁ incurs no approximation errors. Therefore, the first-hitting sampler (FHS) is theoretically equivalent as simulating the continuous-time reverse Markov sampling process. FIG. 2 illustrates the token-by-token sampling method 200, in accordance with an embodiment. The comparison between the FHS and the original sampling procedure is illustrated in FIG. 3.

The FHS demonstrates appealing properties:

Tackling the Sampling Inefficiency The FHS can tackle the two inefficiency problems described above. Firstly, as the categorical sampling is only conducted for determining the transition target of the single chosen mask token at each step, the total computation cost is reduced to O(L|X|).

Secondly, the first-hitting time τₙ can be sampled independently and asynchronously across different samples in a batch, avoiding performance degradation in batched sampling.

Connection to the Sampling of Masked Models When the network parameterization is independent of the time, the FHS in Algorithm 1 can be completely free from the time and become a token-by-token decoding process akin to masked models. This connection serves as supporting evidence for the typical sampling procedure of masked models, as it is theoretically equivalent to the more principled reverse Markov sampling process of MDMs.

### Parallel Decoding

The token-by-token decoding process of MDMs can be extended to parallel decoding by unmasking multiple tokens per step, as the network μ_{θ} predicts tokens at all positions. This enables speed-quality trade-offs similar to diffusion models. Parallel decoding essentially reuses the previous network output to reduce the NFE, thus functioning as an approximation method.

For parallel decoding, suppose the sampling step is N and the sequence length is L, a decoding schedule

$${\{ {L}_{n} \}}_{n = 1}^{N}$$

is defined which satisfies

$${\sum }_{n = 1}^{N} {L}_{n} = L$$

to specify the number of tokens decoded at each step. This includes the token-by-token decoding as a special case where N=L and Lₙ=1. In practice, the same number of tokens may be decoded per step so that L is divisible by N.

Algorithm 2 provides an embodiment of first hitting sampling of MDMs with parallel decoding, which can be interpreted as a first-order method.

Algorithm 2

Require: the sequence length L, the vocabulary X = {0, . . . , m − 1, m} where m is the mask
token, the noise schedule αₜ and its inverse function α − 1, the pretrained masked diffusion model
μ_{θ}, the number of sampling steps N, the decoding schedule
${\{ {L}_{n} \}}_{n = 1}^{N}$

| | |
|---|---|
| 1: | x_{L} ← [m m . . . m] |
| 2: | τ_{L} ← 1 |
| 3: | l ← L |
| 4: | for n ← N to 1 do |
| 5: | for i ← 1 to Lₙ do |
| 6: | Sample uₗ ~ U(0, 1) |
| 7: | ${τ}_{L} - 1 ← {α}^{- 1} ( 1 - {u}_{l}^{\frac{1}{l}} ( 1 - {α}_{{τ}_{l}} ) )$ |
| 8: | if i = 1 then |
| 9: | μ ← μ_{θ}(xₗ, τₗ₋₁) |
| 10: | end if |
| 11: | Randomly and uniformly select an index k from |
| | $\{ j : {x}_{l}^{( j )} = m \}$ |
| | (i.e., masked positions in xₗ) |
| 12: | ${x}_{l - 1} ← {x}_{l} , {x}_{l - 1}^{( k )} ← x \sim Cat ( {μ}^{( k )} )$ |
| 13: | l ← l − 1 |
| 14: | end for |
| 15: | end for |

Output: X₀

To reduce the approximation error, a high-order sampler is used for MDMs. In one embodiment, as shown in FIG. 4, the sampler employs a method 400 that estimates a prediction at one or more sampling steps by extrapolating from previous network predictions. In another embodiment, as shown in FIG. 4, the sampler utilizes a predictor-corrector method to refine the samples.

An embodiment of the method 400 in FIG. 4 is provided in Algorithm 3. Algorithm 3 leverages Lagrange polynomials to interpolate the previous network outputs (predictions) along the time axis, yielding an approximate network prediction for the current time step. The present implementation only uses the two most recent predictions, making it a second-order method, as higher-order methods may tend to degrade performance.

Algorithm 3

Require: the sequence length L, the vocabulary X = {0, . . . , m − 1, m} where m is the mask
token, the noise schedule αₜ and its inverse function α − 1, the pretrained masked diffusion model
μ_{θ}, the number of sampling steps N, the decoding schedule
${\{ {L}_{n} \}}_{n = 1}^{N}$

| | |
|---|---|
| 1: | x_{L} ← [m m . . . m] |
| 2: | τ_{L} ← 1 |
| 3: | l ← L |
| 4: | for n ← N to 1 do |
| 5: | for i ← 1 to Lₙ do |
| 6: | Sample uₗ ~ U(0, 1) |
| 7: | ${τ}_{L} - 1 ← {α}^{- 1} ( 1 - {u}_{l}^{\frac{1}{l}} ( 1 - {α}_{{τ}_{l}} ) )$ |
| 8: | if i = 1 then |
| 9: | μ ← μ_{θ}(xₗ, τₗ₋₁) |
| 10: | τ ← τₗ₋₁ |
| 11: | end if |
| 12: | if n = N then |
| 13: | \hat{μ} = μ |
| 14: | else |
| 15: | $μ = \frac{{τ}_{l - 1} - \tilde{τ}}{τ - \tilde{τ}} μ + \frac{{τ}_{l - 1} - \tilde{τ}}{τ - \tilde{τ}} \tilde{μ} ( Lagrange interpolation )$ |
| 16: | end if |
| 17: | Randomly and uniformly select an index k from |
| | $\{ j : {x}_{l}^{( j )} = m \}$ |

(i.e., masked positions in xₗ)

| | |
|---|---|
| 18: | |
| 19: | l ← l − 1 |
| 20: | end for |
| 21: | \tilde{μ} ← μ |
| 22: | \tilde{τ} ← τ |
| 23: | end for |

Output: x₀

An embodiment of the method 500 in FIG. 5 is provided in Algorithm 4. Algorithm 4 employs a predictor-corrector approach, refining the first-order decoding result at the last step using the current network prediction, also resulting in a second-order method. After refining the intermediate sample, the method avoids feeding it back into the network for prediction updates, thus preventing extra NFEs.

Algorithm 4

Require: the sequence length L, the vocabulary X = {0, . . . , m − 1, m} where m is the mask
token, the noise schedule αₜ and its inverse function α − 1, the pretrained masked diffusion model
μ_{θ}, the number of sampling steps N, the decoding schedule

| | |
|---|---|
| 1: | x_{L} ← [m m . . . m] |
| 2: | τ_{L} ← 1 |
| 3: | l ← L |
| 4: | for n ← N to 1 do |
| 5: | for i ← 1 to Lₙ do |
| 6: | Sample uₗ ~ U(0, 1) |
| 7: | ${τ}_{L} - 1 ← {α}^{- 1} ( 1 - {u}_{l}^{\frac{1}{l}} ( 1 - {α}_{{τ}_{l}} ) )$ |
| 8: | if i = 1 then |
| 9: | μ ← μ_{θ} (xₗ, τₗ₋₁) |
| 10: | if n < N then |
| 11: | xₗ ← \hat{x} |
| 12: | for r ← 1 to Lₙ₊₁ do |
| 13: | Randomly and uniformly select an index k from |
| 14: | ${x}_{l}^{( k )} ← x \sim Cat ( {μ}^{( k )} )$ |
| 15: | end for |
| 16: | end if |
| 17: | \hat{x} ← xₗ |
| 18: | end if |
| 19: | Randomly and uniformly select an index k from |
| | $\{ j : {x}_{l}^{( j )} = m \}$ |

(i.e., masked positions in xₗ)

| | |
|---|---|
| 20: | |
| 21: | l ← l − 1 |
| 22: | end for |
| 23: | end for |

Output: x₀

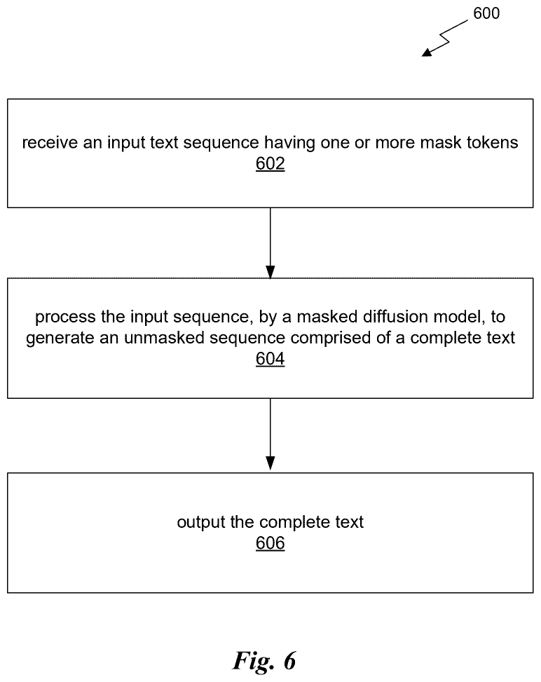

FIG. 6 illustrates a text generation method 600, in accordance with an embodiment. The text generation method 600 may be carried out in the context of the embodiments of the masked diffusion model described herein. The text generation method 600 is one exemplary use of the masked diffusion model described in the embodiments above.

In operation 602, an input text sequence having one or more mask tokens is received. The input text sequence refers to an incomplete text representation comprised of one or more text elements and one or more mask tokens in a sequence. In operation 604, the input sequence is processed, by a masked diffusion model, to generate an unmasked sequence comprised of a complete text. In operation 606, the complete text is output.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

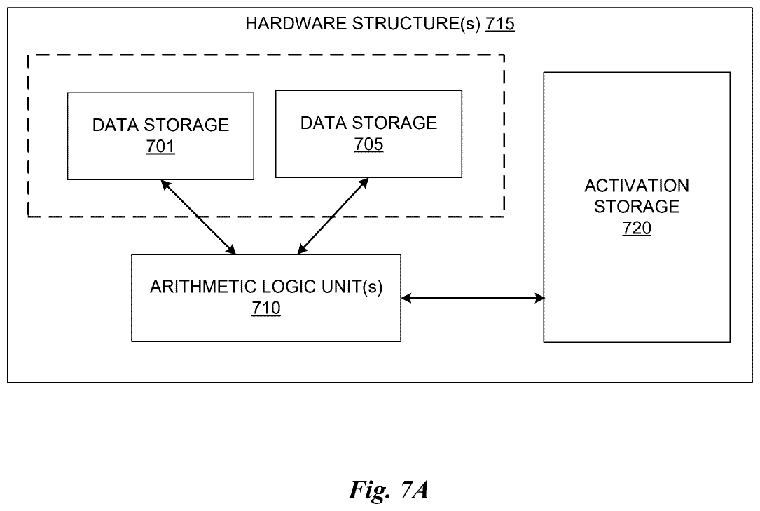

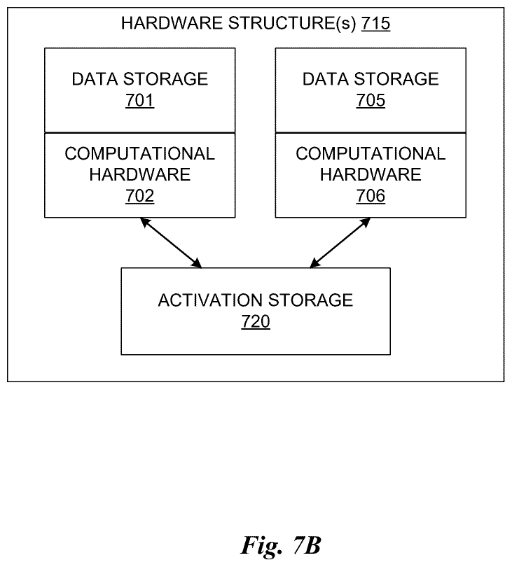

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

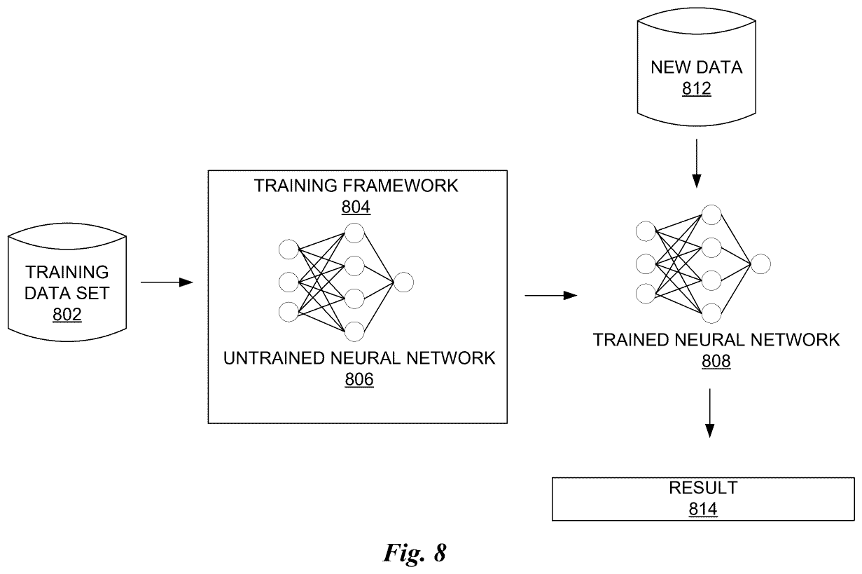

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

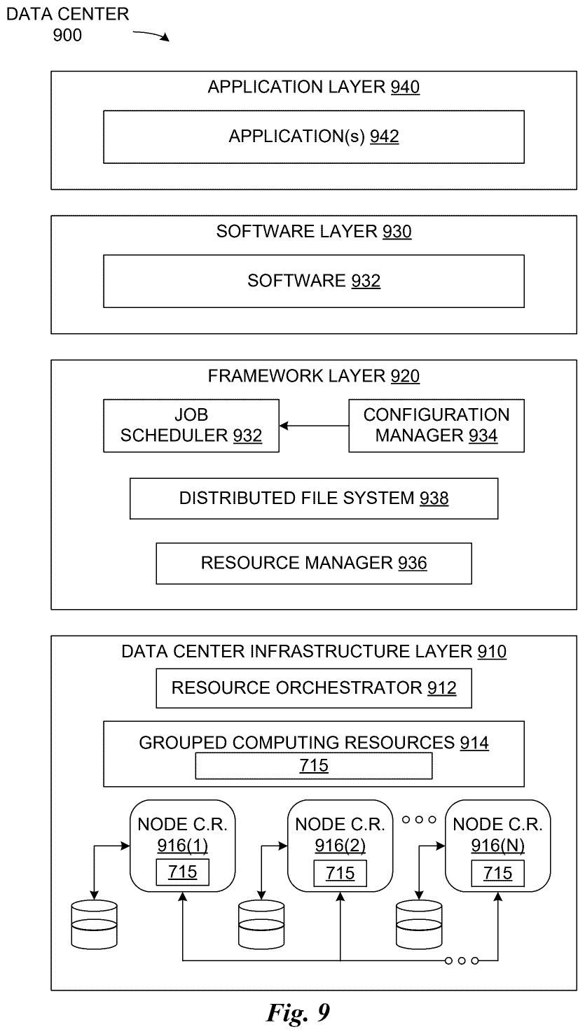

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed to provide in painting of a target image using a diffusion model. In accordance with FIGS. 1-6, embodiments may provide a diffusion model usable for performing inferencing operations and for providing inferenced data. The diffusion model may be stored (partially or wholly) in one or both of data storage 701 and 705 in inference and/or training logic 715 as depicted in FIGS. 7A and 7B. Training and deployment of the diffusion model may be performed as depicted in FIG. 8 and described herein. Distribution of the diffusion model may be performed using one or more servers in a data center 900 as depicted in FIG. 9 and described herein.

What is claimed is:

1. A method, comprising:
at a device:
unmasking one or more mask tokens included in an input sequence over a plurality of sampling steps, by a masked diffusion model, to generate an unmasked sequence, wherein a prediction made during at least one sampling step of the plurality of sampling steps is one of:
estimated using linear extrapolation from two or more prior predictions made during respective prior sampling steps of the plurality of sampling steps, or
computed from a current decoding result refined from a prior prediction made during a prior sampling step of the plurality of sampling steps; and
outputting the unmasked sequence.

2. The method of claim 1, wherein the input sequence is an encoding of an image having one or more masked regions.

3. The method of claim 2, wherein the unmasked sequence is a complete image.

4. The method of claim 1, wherein the input sequence is an encoding of a text having one or more masked portions.

5. The method of claim 4, wherein the unmasked sequence is a complete text.

6. The method of claim 1, wherein the mask tokens are noisy tokens in the input sequence.

7. The method of claim 1, wherein the input sequence includes a plurality of mask tokens.

8. The method of claim 7, wherein the unmasking of at least two mask tokens in the plurality of mask tokens is performed in parallel.

9. The method of claim 1, wherein the unmasking includes a token-by-token sampling process.

10. The method of claim 9, wherein at least one mask token is unmasked during each sampling step of the plurality of sampling steps.

11. The method of claim 1, wherein the prediction made during the at least one sampling step of the plurality of sampling steps is estimated using the linear extrapolation from the two or more prior predictions made during the respective prior sampling steps of the plurality of sampling steps.

12. The method of claim 11, wherein Lagrange polynomials are used to interpolate the two or more prior predictions along a time axis to estimate the prediction at a current sampling step.

13. The method of claim 11, wherein the two or more prior predictions include two of the most recent predictions made by the masked diffusion model.

14. The method of claim 1, wherein the prediction made during the at least one sampling step of the plurality of sampling steps is computed from the current decoding result that has been refined from the prior prediction made during the prior sampling step of the plurality of sampling steps.

15. The method of claim 14, wherein the current decoding result that has been refined is prevented from being fed back into the masked diffusion model for prediction updates.

16. The method of claim 1, wherein the at least one sampling step of the plurality of sampling steps makes the prediction without processing through the masked diffusion model.

17. The method of claim 1, wherein when a number of sampling steps in the plurality of sampling steps is less than or equal to a first threshold, then the prediction made during the at least one sampling step of the plurality of sampling steps is estimated using the linear extrapolation.

18. The method of claim 17, wherein the first threshold is 128.

19. The method of claim 1, wherein when a number of sampling steps in the plurality of sampling steps is greater than or equal to a second threshold, then the prediction made during the at least one sampling step of the plurality of sampling steps is computed from the current decoding result.

20. The method of claim 19, wherein the second threshold is 256.

21. A system, comprising:
a non-transitory memory comprising instructions; and
one or more processors in communication with the non-transitory memory, wherein the one or more processors execute the instructions to:
unmask one or more mask tokens included in an input sequence over a plurality of sampling steps, by a masked diffusion model, to generate an unmasked sequence, wherein a prediction made during at least one sampling step of the plurality of sampling steps is one of:
estimated using linear extrapolation from two or more prior predictions made during respective prior sampling steps of the plurality of sampling steps, or
computed from a current decoding result refined from a prior prediction made during a prior sampling step of the plurality of sampling steps; and
output the unmasked sequence.

22. The system of claim 21, wherein the input sequence includes a plurality of mask tokens, and wherein the unmasking of at least two mask tokens in the plurality of mask tokens is performed in parallel.

23. The method of claim 1, wherein the unmasking includes a token-by-token sampling process, and wherein at least one mask token is unmasked during each sampling step of the plurality of sampling steps.

24. A non-transitory computer-readable media storing computer instructions which when executed by one or more processors of a device cause the device to:
unmask one or more mask tokens included in an input sequence over a plurality of sampling steps, by a masked diffusion model, to generate an unmasked sequence, wherein a prediction made during at least one sampling step of the plurality of sampling steps is one of:
estimated using linear extrapolation from two or more prior predictions made during respective prior sampling steps of the plurality of sampling steps, or
computed from a current decoding result refined from a prior prediction made during a prior sampling step of the plurality of sampling steps; and
output the unmasked sequence.

25. The non-transitory computer-readable media of claim 24, wherein the input sequence includes a plurality of mask tokens, and wherein the unmasking of at least two mask tokens in the plurality of mask tokens is performed in parallel.

26. The non-transitory computer-readable media of claim 24, wherein the unmasking includes a token-by-token sampling process, and wherein at least one mask token is unmasked during each sampling step of the plurality of sampling steps.
